(19) United States
(12) Patent Application Publication
(10) Pub. No.: US 2024/0421751 A1
(43) Pub. Date: Dec. 19, 2024

(54) Solar Mounting Solutions

(71) Applicant: David Simonsen, Redding, CA (US)

(72) Inventor: David Simonsen, Redding, CA (US)

(21) Appl. No.: 18/811,727

(22) Filed: Aug. 21, 2024

Related U.S. Application Data
(63) Continuation of application No. PCT/US1923/013546, filed on Feb. 21, 2023.
(60) Provisional application No. 63/312,134, filed on Feb. 21, 2022.

(51) Int. Cl. H02S 20/22; F24S 25/634; H02S 40/40

(52) U.S. Cl. CPC H02S 20/22; H02S 40/40; F24S 25/634

(57) ABSTRACT

Disclosed herein a novel and useful solar mounting solution that includes a plurality of specially shaped structural thermal clips, specially shaped structural and thermal mounting washers, structural hardware struts, a cooler/heat sink, structural solar panel mounting clips, and solar panel frames, which aid to provide better thermal performance that can be used on any structure, but particularly on the sides of buildings, or Building Integrated Photovoltaics (BIPV). The solar mounting solution also aids to minimize vibration and support hardware such as, but not limited to, conductors, conduits, pipes, equipment such as microinverters. The seismic rated solar mounting system is lightweight, strong, durable, inexpensive, and facilitates mounting of solar panels onto buildings and other structures.

### CROSS-REFERENCE TO RELATED APPLICATIONS

This application claims benefit of the National Stage of International Application No. PCT/US2023/13546, filed on Feb. 21, 2023, which claims the benefit of U.S. Provisional Application No. 63/312, 134, filed on Feb. 21, 2022.

### BACKGROUND OF THE INVENTION

### Field of Invention

The present invention relates primarily to a field of solar panels, and more particularly it relates to a novel system for mounting solar panels onto buildings and other structures including, but not limited to, solar farms.

### Description of Related Art

There has been a little change on mounting solutions for solar panels onto buildings and other structures, with expensive and cumbersome aluminum extrusions and clips being used traditionally. Additionally, there have been no advancements in mounting hardware such as conduits, conductors, and micro-inverters onto building facades for Building Integrated Photovoltaics which are mounted over exterior insulation. For solar panel power conversion efficiency (PCE) in relation to deflected or reflected light, there have been no great advancements without significant losses to PCE.

Hence, there is a significant need and void in the market to invent novel and improved solar mounting solutions. The present invention is hereinafter disclosed, which provides complete solar mounting systems which address the issues listed above as well as reductions in up-front costs, increased thermal efficiency for building integrated PV, means for equipment heat dissipation, structural hardware mounting, and increased collection of solar rays resulting in less glare from solar panels.

### SUMMARY OF THE INVENTION

In accordance with the present application, a novel and useful solar mounting system is hereinafter provided including specially shaped structural thermal clips, specially shaped structural and thermal mounting washers, structural hardware struts, a micro-inverter cooler/heat sink, structural solar panel mounting clips, solar panel frames, a light-directing anti reflective material, replacement reveal strips, a highly efficient dual T-slot continuous insulation mounting sub-girt with adjustable clips, structural reveal strip and their attachment method, an ACM/MCM panel stiffener, and girt stabilizers.

All shaped wire products such as the structural thermal clips, hardware struts and solar panel mounting clips will be made of fully hardened stainless or galvanized carbon steel spring wire and formed on manual or automated wire bending machines. The wires may be welded, press formed and/or twist formed together to make any conceivable shape. They may have holes or slots for mechanical fasteners to either hold them fixed or allow them to move within the slot. They may have plastics, foams, butyl materials, adhesives, self-locking washers and/or other materials added onto or adjacent to them for better thermal performance, as a safety coating including for electrical insulation, to minimize vibration (sound), or to help connect or otherwise interact with itself or other materials by being more or less sticky or prone to wear. The ends of the wires may have threads added by use of dies so that the male threaded ends can connect into female threaded attachments. The wires may be formed into coils so that when a screw is inserted into it the coil will allow the fastener to enter but reversing the screw will tighten the coils to help prevent it from backing out or cause enough additional friction to prevent the fastener from backing out. Because additional mounting holes help prevent formed wire movement and can add rigidity, all formed wires may have one or more mounting hole. The formed wires may press against and keep tension on another component, or act to keep it in a substantially fixed position. Hardware mounting struts may have one or more independent locations where conduits, conductors, pipes, and other materials may pass therethrough.

Isolators may be made using plastic injection molding processes, or sheets of stainless-steel with an adhered EPDM backer which may manufactured by a turret press. Custom washers may be made of a material such as stainless steel with or without an EPDM type of backer and manufactured with a turret press to add anti-reversal mechanisms, protrusions, and convex shapes while a break press may be used to create hems or other bends required.

The stainless steel structural thermal clips will be used over a plastic isolator or custom stainless EPDM backed washer isolators when connected to a substrate in order to help reduce thermal transfer into a building, and the isolators help spread the pressure of loads over a larger surface of the building's substrate as well as to help prevent water from entering the substrate underneath the isolators. The thermal clips' mounting holes will be formed in a clockwise direction so that the mounting holes don't try to open its shape up when a fastener is tightening, and the very end of the mounting hole wire will be formed upwards so that when the screw is completely seated the upwardly formed end will act as a compressed lock washer to prevent the screw from backing out by engaging the bottom side of the head of the fastener. These thermal clips may be triangularly shaped to obtain maximum performance for supporting loads, and the triangular shape may be made using one or more wires. The formed wires will allow for adjustability of the girts so that the building can be leveled and planed prior to façade material mounting. If movement in any direction is needed for seismic or other reasons, the formed wires can be made to be less rigid by adding length such as in the shape of coils and bends between 2 points. The wire clips can be made to accommodate vertical, horizontal, and diagonal sub-girts. The thermal clips may be used vertically for walls or horizontally for roofs and soffits.

The highly efficient dual T-slot continuous insulation mounting sub-girt and adjustable clips will be fabricated from materials such as extruded aluminum with various holes and slots machined into them with a manual or CNC milling machine. The stainless-steel panel wire clips may fit inside the T-slots and then fastened in place with a fastener positioned on top of the T-slot, or the stainless panel wires may be fastened directly to the top of the T-slots if desired. A self-sustained structural dual T-slot extrusion may be made which will allow a fastener through two or more locations before exiting and self-drilling into a steel stud or other sub-structure. This multiple point-of-contact on the fastener causes loads to be supported by the bend strength of the fasteners because the fastener is forced to hold a straight position. The T-slots may have holes drilled into them to allow a fastener head to enter through the hole so that it doesn't need to be brought in from one end or the other.

The structural solar panel mounting clips slide or snap into or onto the return legs of the solar panel frames which is shown in the drawings and don't require fasteners to mount to the panels themselves. The stainless-steel solar panel mounting clip attachment holes will be fastened into the sub-framing or substrate to permanently fix the mounting clips in a fixed position, which then supports and holds a solar panel in a fixed position as well. Some variations of the solar panel mounting clip allow for thermal expansion of a panel, and others don't, and more than one type of solar panel mounting clip may be used with a single panel. The panel wires may be made less rigid by adding coils, bends or otherwise lengthening it in general in order to allow them to flex for movements such as seismic and dynamic loads, which will allow the facade material to move without causing it to deform. On a given solar panel there may more than one type of solar panel mounting clip used.

Microinverters must be cooled to work properly. The micro-inverter cooler/heat sink is designed to keep the micro-inverter and other electric/electronic equipment away from contact with the insulation and/or solar panels, where such contact may otherwise cause equipment to overheat and malfunction. The cooler/heat sinks do this by allowing air to pass all around the devices, while at the same time helping as a heat sink to help draw some of the heat away from the device. They may compress the insulation yet still allow air flow between the insulation and device. They may be made in an extrusion process if made of aluminum with holes machined out of it; injection molded as a complete part if plastic, or 3D printed of almost any material including fiber reinforced plastics. They are designed to have minimal contact with the devices in order to block as little heat as possible. They may be made separate from the microinverters or other devices or built into the framing of the microinverter or other devices as a uni-frame and used as part of the microinverter regardless of its application. Some of the cooler/heat sink materials may be removed or eliminated to reduce materials and process costs. The cooler/heat sinks can be made to allow the microinverter to be similarly covered from all sides to prevent contact with any materials, allowing for un-interrupted cooling from all directions.

The solar panel frame may be made of a metal such as stainless steel using a turret press and brake press to form it. It may also be made of a composite material such as aluminum composite material (ACM/MCM). The frames may be adhered to the back of solar panels with an adhesive or other mechanical fastening option such as angle supports and fasteners. The frame portion adjacent to the solar panel modules may be solid, perforated, or expanded material to allow for cooling behind the panel. The returns of the solar panel frame may be used to help direct hot air out the sides of the panels and allow for cooler air to enter from other locations, such as from the bottom of the panels when they are mounted in a vertical orientation. An ACM frame, or formed aluminum sheet frame, may have a portion of the outer skin surface removed so that thin-film solar modules may be adhered to the inside of the ACM frame, mounted flush with the outside of the ACM.

The replacement reveal may be a material such as ACM/MCM or aluminum sheet which can be machined to provide holes for a fastener attached to a tool, such as a nut-driver, to pass through the holes to fasten the solar panel mounting clips to the substrate. Once the fasteners are tightened, the tool may be removed and the replacement reveal strip cover or caps may be adhesively installed for permanent fixing.

The light-directing anti reflective material (lens) will be a form of a Fresnel lens, but specific to solar panels. To best capture sunlight and direct it into the solar collectors, horizontal grooves may be used for south and north facing walls while substantially vertical grooves may be used for east and west facing walls. The direction of the grooves would be specific to the direction the building is facing in order to collect the most sunlight throughout the year at and between the winter and summer solstices. The shape of the grooves may be any shape which allows the most amount of sunlight to reach the solar collectors, such as equilateral triangle shapes or right triangle shapes, and includes consideration for the angle of incidence of the light and capturing it through an adjacent plane of an adjacent groove, whether on the same or different plane. A film which helps prevent dust build-up may be used over the outer surface for cleanliness, such as a product like Solar Share. The grooves may be on the outside where the sun first contacts the solar panel, but these grooves may also be on the inside with the anti-reflective material acting as part of the packaging for the solar module, and the interior grooves being used to further distribute the light in advantageous directions as well as to be used for better adhesion within the solar module where adhesives are used. The grooves on the outside of the panel will help prevent glare because they are redirecting the light into the solar panel or in directions other than a single direction as would a flat sheet of glass. The lens may be made of a material such as glass or plastic, and manufactured using means such as injection molding, embossing or machining.

Structural reveal strips may be made of ACM/MCM or a material such as aluminum sheet which can be stapled, clinched, or otherwise mechanically attached to differing or like materials. These structural reveal strips are commonly used for architectural purposes only, but the proposed solution makes them not only structural, but potentially waterproof is adhesive is used between them and the adjoining material. Structural reveal strips are permanently attached to the panel returns so that they create a full panel assembly which includes the reveals, where the reveals are traditionally inserted following structural attachment of the panel. The structural reveal strips attach to the returns of the panels, attach more than one return of the panel together, and help to maintain the shape of the panel by fixing the corners of the panels into specific locations. These structural reveal strips may be used on one or more sides of a panel in order to control the amount of water to enter behind the panel, as well as to control the amount of air behind the panel to evaporate any water which does get behind the panel. These structural reveal strips will generally use ACM/MCM material which would normally be scrapped because the widths are too small. Structural reveal strips may also control the amount of water which enters behind a panel and the direction the water is moved once installed. A portion of the structural reveal strip may rest inside of the flanges inside the panel cavity, and that portion may be routed and bent inwards toward the inside-back of the panel to force water into the back of the panel, where the water can then be evacuated through weep holes in the bottom of the panel and guttered away from behind the panels.

An extrusion or formed sheet metal means of making a solar panel mounting clip is possible by mimicking the shapes of the formed stainless steel solar panel mounting clips and should be considered obvious for the way these attachment systems work and are used.

A formed ACM/MCM panel stiffener to replace aluminum extrusion and formed sheet stiffeners is proposed, which uses scrap ACM/MCM to make the shape to avoid the significant amount of waste associated with metal panel fabrication and assembly. Stiffeners are required for any panel which doesn't meet the deflection requirements for facade materials. Because staples are used as the fastening mechanism for these ACM/MCM stiffeners, they wilt seat against the ACM/MCM in elevation below the thickness of the double sided VHB tape which will attach the stiffener to the back of the panel. The ACM/MCM/sheet metal stiffener is made in the shape of a triangle because it is the strongest shape known, and even though some of the material may be routed away to make the bends, the performance of the shape is somewhat contingent on the fact that the bend locations will contact each other to help strengthen these areas as much as possible.

It may be apparent that novel and useful Solar Mounting Solutions have been hereinabove described which work and are used in a manner not consistent with conventional products and methods.

It is therefore an object of the present solar mounting application to provide a lightweight, strong, durable, inexpensive, and seismic rated solar panel mounting system with the best thermal efficiency which can be used on any structure, but particularly on the sides of buildings, or Building Integrated Photovoltaics (BIPV).

Another object of the solar mounting system is to support hardware with structural hardware struts for materials such as conductors, conduits, pipes, and equipment such as microinverters outside of the exterior insulation and without contacting or penetrating the weather barrier, and where the hardware struts may be coated with an insulation material to help prevent electrical and thermal conductivity as well as to help reduce vibration for noise reduction. The hardware struts may be hollow to save on materials, as well as to act as a heat sink to pull heat away from devices such as microinverters.

Another object of the solar mounting system is to structurally support more than one type of hardware, such as conductors, where each conductor is individually captured in a specific wire “harness” to allow for very clean and organized conductor circuitry.

Another object of the solar mounting system is to provide an anti-reflective lens which adds to the Power Conversion Efficiency instead of taking away from it by using a circuitous path for light to be directed towards the solar collectors.

Another object of the solar mounting system is to support solar panels using fully hardened stainless steel spring wires for attachment into any panel holes, slots, or shapes which the panels are made, including new thin film and flexible film solar module options, and where the solar panel mounting clips may have an included shape for a reveal strip to be inserted into, whether the reveal strip is architectural or structural.

Another object of the solar mounting system is the invention of a replacement reveal which allows a solar panel to be structurally mounted to a building through holes in the middle of the replacement reveal, and then then the holes are covered or inserted into with covers which are adhered to the reveal strip to provide a uniform appearance.

Another object of the solar mounting system is to stabilize sub-girts with one or more elongated high-tensile strength straps, wires or formed shapes which can be mounted through holes in the sub-girts, onto the sub-girts, or both, and fastened together with the sub-girt for more twist resistance of the sub-girt and to provide a more uniform load on the fasteners of the thermal clips supporting the sub-girts to the wall substrate.

Another object of the solar mounting system is to provide a cooler/heat sink which works as an independent and added component to microinverters, or which may be manufactured as part of the microinverter and shaped to match to prevent the microinverter from directly contacting insulation, panels and other materials which would prevent air-cooling of the microinverters.

Another object of the solar mounting system is to mechanically attach solar panels to buildings without fastening the solar panel mounting clips to the solar panel itself, where the solar mounting clips attach into or onto parts of the panel and permanently hold the panel in a fixed position once the solar panel mounting clips are fastened to the substrate.

Another object of the solar mounting system is to support the dead load of a solar panel from the top only, and then to attach the bottom of the adjacent solar panel above into the same solar panel attachment clip without any fastening at all so that installation of the panels is very fast and economical to do in the field.

Another object of the solar mounting system is to provide specialized washers, or support plates, which have at least one mounting hole with anti-reversal serrations for fasteners and at least one locating protrusion which helps prevent rotation when the fastener is being installed. The protrusion of course can be replaced with another fastener if desired. The support plate has at least one hemmed side which helps to support a reveal strip, and the shape of the support plate allows for structural support to prevent the formed solar panel attachment clip from moving in any direction, and specifically outwards when the panel system is introduced to dynamic negative wind loads.

Another object of the solar mounting system is to support panel loads using the benefits of a structural reveal strip which is mechanically attached to the solar panel frame thereby becoming part of the solar panel frame and increasing its overall load capacity during dynamic positive and negative wind load conditions due to its “ply-metal” added strengths, especially when tying perpendicular panel flanges together to increase the overall strength of the panel by distributing tensile and bend loads more evenly to more sides of a panel.

Another object of the solar mounting system is to use stainless steel staples to connect more than one piece of ACM/MCM or aluminum (or other metal which a staple can penetrate through) together permanently.

The invention possesses other objects and/or advantages especially as concerns particular characteristics and features thereof which will become apparent as the specification continues. Variations of the invention and its parts may be combined to make parts with similar or combined concepts.

### BRIEF DESCRIPTION OF SEVERAL VIEWS OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific structures disclosed herein. The description of a structure referenced by a numeral in a drawing is applicable to the description of that structure shown by that same numeral in any subsequent drawing herein.

FIG. 1 illustrates a 3D isometric elevation view of a complete solar array of the present application, according to an embodiment of the present invention.

FIG. 2 illustrates a 3D isometric elevation view of a thermal mounting clip A and plastic isolator AB of FIG. 1, according to an embodiment of the present invention.

FIG. 3 illustrates a 3D isometric elevation view of the preferred embodiments of the hardware struts D and microinverter cooler/heat sink C as shown in a closer look of the upper right-hand corner of FIG. 1.

FIG. 4 illustrates a 3D isometric plan view of the preferred embodiment of a hardware strut D for supporting a microinverter as well as the preferred embodiment of the microinverter cooler/heat sink C.

FIG. 5 illustrates a 3D isometric plan view of the preferred embodiment of a hardware strut for supporting a microinverter shown in FIG. 4.

FIG. 6 illustrates a 3D isometric plan view of the preferred embodiment of the microinverter cooler/heat sink shown in FIG. 4.

FIG. 7 illustrates a 3D isometric elevation view of the preferred embodiment of a hardware strut attached to a sub-girt and specific to containment and separation of conductors as shown, wherein only a single conductor separator is shown, there may be multiple separators which aid in the organization of many different conductors.

FIG. 8 illustrates a 3D isometric elevation view of the preferred embodiment of a hardware strut shown in FIG. 7 specific to containment and separation of conductors or other hardware.

FIG. 9 illustrates a 3D isometric section view of a solar panel array assembly including the preferred embodiment of a replacement reveal strip, solar panel mounting clips, and a panel frame.

FIG. 10 illustrates a 3D isometric elevation view a solar panel mounting clip shown in FIG. 9, according to an embodiment of the present invention.

FIG. 11 illustrates a 3D isometric elevation view of a solar panel having an anti-reflective lens oriented in a direction which allows the most sunlight to be directed into the solar collectors of the solar panel. The angle of incidence of the light will change the direction of the light being redirected into the solar collectors.

FIG. 12 illustrates a 3D isometric plan view of the preferred embodiment of a replacement reveal with hole covers not installed.

FIG. 13 illustrates a 3D isometric plan view of an alternate replacement reveal, according to an embodiment of the present invention.

FIG. 14 illustrates a 3D isometric elevation view of the preferred embodiment of the vertical thermal clip and the preferred isolators of the present invention.

FIG. 15 illustrates a 3D isometric elevation view of the preferred horizontal thermal clip and sub-girt assembly with the preferred girt stabilizers.

FIG. 16 illustrates a 3D isometric elevation view of the preferred horizontal thermal clip shown as “I” in FIG. 15.

FIG. 17 illustrates a 3D isometric plan view of how the preferred girt stabilizers, shown as “K” in FIG. 15, attach to the sub-girt and to each other to keep the sub-girt planed to the wall and prevent it from twisting under a load.

FIG. 18 illustrates a 3D isometric elevation view of the horizontal thermal clip supporting the sub-girt and adjustable panel clips of various types, according to an embodiment of the present invention.

FIG. 19 illustrates a 3D isometric elevation view of holes in a dual T-slot sub-girt which allow fasteners to be installed without installing them from the ends of the sub-girt, along with various panel mounting clips.

FIG. 20 illustrates a 3D isometric plan-section view of the preferred embodiment of a dual T-slot sub-girt capable of meeting the current ASH RAE 90.1 definition of Continuous Insulation and having an optional compression plate for increased structural strengths when the sub-girt is abutted against the insulation.

FIG. 21 illustrates a 3D isometric elevation-section view of a sliding solar panel clip with frame, and reveal strip supported on the bottom by the fasteners and where the reveal strip may act as a spring to keep contact with both panel frames simultaneously, and the fasteners act as a fulcrum point.

FIG. 22 illustrates a 3D isometric plan view of the sliding solar panel clip of FIG. 21, according to an embodiment of the present invention.

FIG. 23 illustrates a 3D isometric elevation-section view of the preferred embodiment of a solar panel attachment clip in a solar array assembly, and where the solar film is embedded into the solar frame.

FIG. 24 illustrates a 3D isometric elevation view of the preferred solar panel attachment clip shown as “M” in FIG. 23.

FIG. 25 illustrates a 3D isometric elevation view of the preferred structural washer/support plate shown as “N” in FIG. 23.

FIG. 26 illustrates a 3D isometric section-elevation view of an alternate solar panel mounting clip in a non-solar array, but with the preferred structural reveals mounted to the panels.

FIG. 27 illustrates a 3D isometric elevation view of the alternate solar panel mounting clip of FIG. 26, according to an embodiment of the present invention.

FIG. 28 illustrates a 3D isometric elevation view of the back of the panel assembly of FIG. 26 with one of the structural reveals “R” removed to see how it helps to attach the perpendicular frame returns to each other and to the structural reveal to strengthen the panel's structural performance.

FIG. 29 illustrates a 3D isometric elevation view of FIG. 28 with the removed structural reveal “R” assembled into its permanent position, and the staple fasteners shown combining multiple structural reveals and multiple panel flanges together simultaneously.

FIG. 30 illustrates a 3D isometric section-elevation view of an alternate extrusion or formed sheet metal imitation of the solar panel attachment clips to show that this type of imitation is obvious.

FIG. 31 illustrates a 3D isometric plan view of an ACM/MCM/formed sheet metal stiffener with double sided tape attached to the bottom and staple fasteners holding the permanent shape of the stiffener.

FIG. 32 illustrates a 3D isometric elevation view of the stiffener of FIG. 31 showing the staple attachment through two of the flanges of the stiffener.

For a better understanding of the invention of this application, reference is made to the following detailed description of the preferred embodiments thereof which should be referenced to the prior described drawings.

### DETAILED DESCRIPTION OF THE INVENTION

Various aspects of the present application will evolve from the following detailed description of the preferred embodiments thereof which should be taken in conjunction with the prior described drawings.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or conducted in a variety of ways. It is to be understood that the phraseology and terminology employed herein is for the purpose of description and not of limitation.

It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “exemplary embodiment,” “an embodiment,” “an alternate embodiment,” “one embodiment,” “another embodiment,” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Reference will now be made in detail to preferred embodiments of the present invention, examples of which are illustrated in the accompanying drawings.

According to an exemplary embodiment of the present invention, a generalized view of a complete solar array is shown in FIG. 1. With reference to FIG. 1, a generalized view of the complete solar array is shown with a thermal mounting clip A with a plastic isolator AB attached to a substrate (not numbered), a sub-girt (not numbered) attached to the thermal mounting clip A, a preferred microinverter strut B is mechanically fastened to the sub-girt (not numbered) on one side and into the microinverter (not numbered) and cooler/heat sink C. Conductors (not numbered) protrude from microinverter (not numbered) and separate into preferred hardware struts D which are attached to an additional adjacent sub-girt (not numbered).

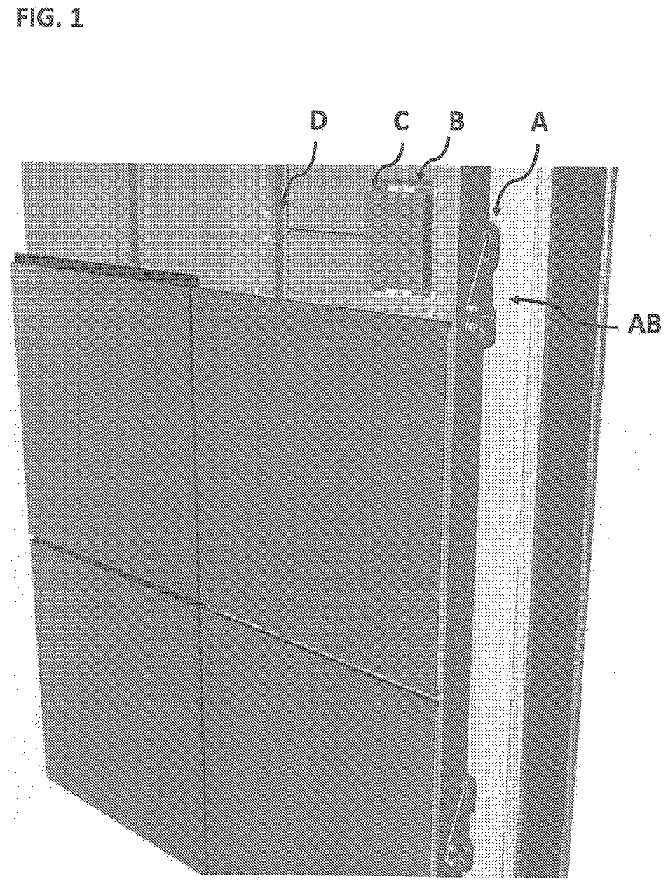

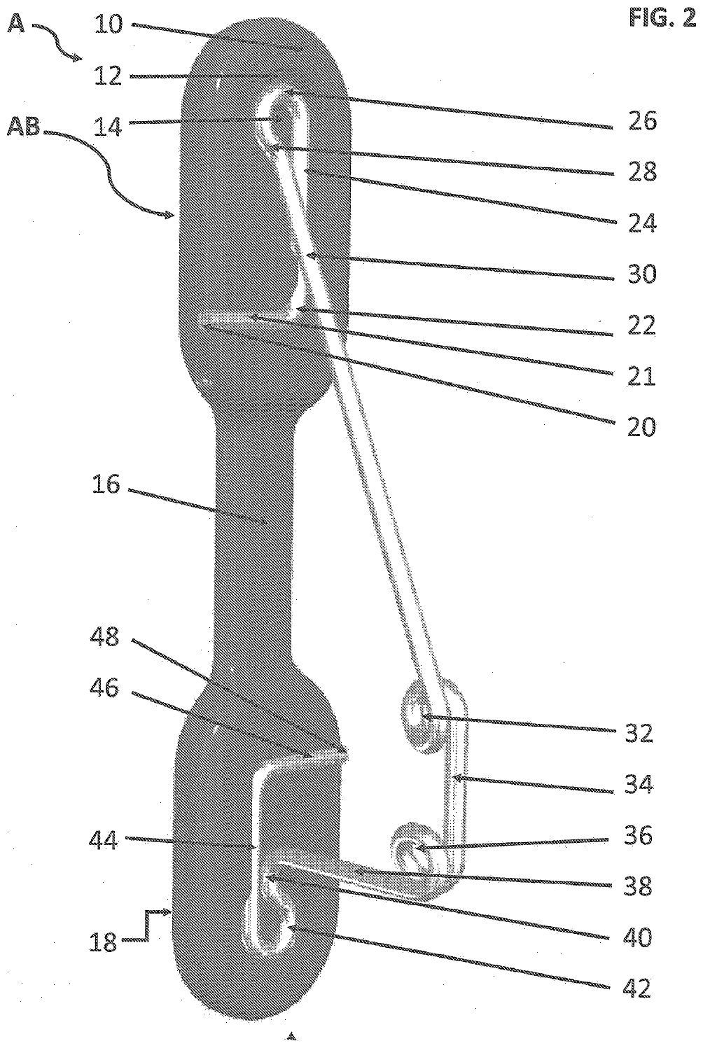

According to a first preferred embodiment of the present invention, an enlarged view of the thermal mounting clip A and plastic isolator AB of FIG. 1 is shown in FIG. 2. Referring now to FIG. 2, the isolator AB comprising of: a top 10 having an inset 12 with a raised hole 14. An intermediate 16 connects the top 10 to a bottom 17 which has similar attributes as the top 10. Recesses 18 are located on the backside of the top 10 and the bottom 17 where the hole 14 penetrates through the thickness of the isolator AB. A small hole 19 is located at a bottom of the hole 14 in both the top 10 and the bottom 17 which acts as a “nyloc” seal against a fastener (not shown) to prevent water intrusion.

Continue referring to FIG. 2, the thermal mounting clip A comprising of: a first end 20 which extends substantially horizontally to a substantially perpendicular first bend 22, which extends to a first leg 24 which extends to a second bend 26 which creates a loop (not numbered) for a fastener (not shown) to pass through it and the isolator AB. The second bend 26 extends to a third bend 28 which extends to a static support leg 30 which extends to a first loop 32, which extends to a second leg 34 which extends to a second loop 36 which extends to a first perpendicular leg 38 which extends to a second perpendicular leg 40 which extends to a third loop 42 which creates a hole (not numbered) for a fastener (not shown) to pass through it and the isolator AB. The third loop 42 extends to a parallel leg 44 which extends to a third perpendicular leg 46 which terminates at a second end 48.

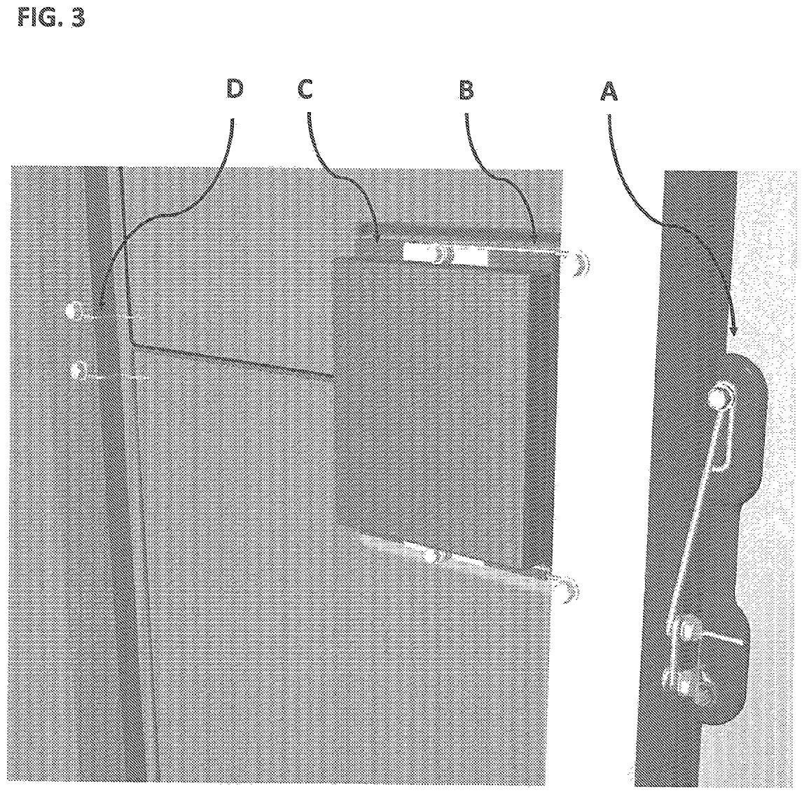

FIG. 3 shows an enlarged view of the upper right-hand corner of FIG. 1, wherein the preferred embodiments of the hardware struts D, the microinverter struts B, and the microinverter cooler/heat sink C are shown in a closer look.

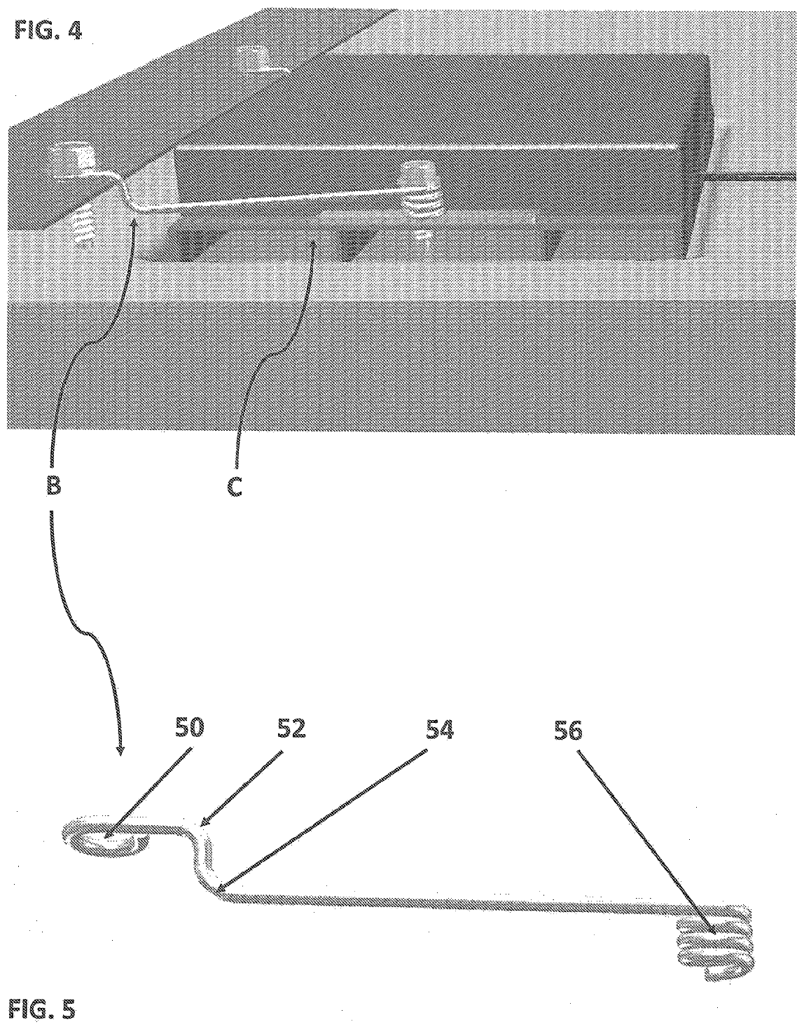

According to a second preferred embodiment of the present invention, FIG. 4 shows the microinverter (not numbered) mechanically attached to the microinverter struts B which are attached to a sub-girt (not numbered) and attached to the cooler/heat sink C, with the cooler/heat sink C compressing insulation (not numbered) yet still allowing air (not shown) to pass through the cooler/heat sink C to cool the microinverter (not numbered). The microinverter strut B pushes down on the insulation (not numbered) when not in contact with the cooler/heat sink C. Further, FIG. 5 shows the microinverter strut B comprising: a mounting hole 50 extending to a leg 51 which extends to a first bend 52 which extends to a first perpendicular leg 53 which extends to a second bend 54 which extends to a second perpendicular leg 55 which extends to and terminates at a mounting coil 56.

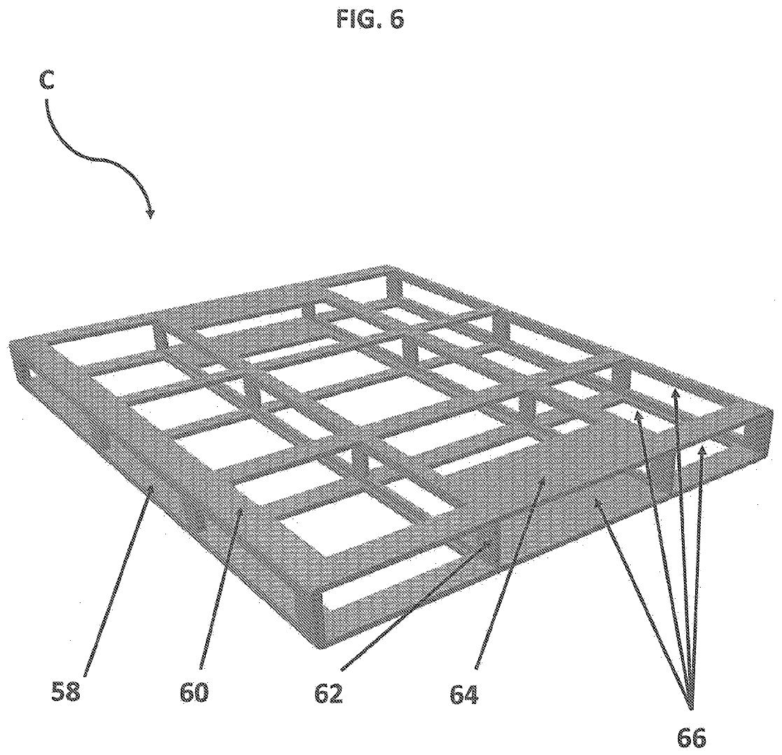

According to a third preferred embodiment of the present invention, FIG. 6 shows the cooler/heat sink C having a plurality of holes 58 and 66 on all sides, as well as a plurality of mounting surfaces 60 and 64 on top and bottom for attachment to the microinverter (not shown) and fasteners (not shown). Moreover, a plurality of vertical supports 62 are located in many places on the cooler/heat sink C as shown in FIG. 6.

According to a fourth preferred embodiment of the present invention, FIG. 7 shows the hardware struts D holding down and organizing conductors (not numbered) while being structurally attached to a sub-girt (not numbered) by fasteners (not numbered), while impaling insulation (not numbered) to support insulation (not numbered) and prevent insulation (not numbered) from moving.

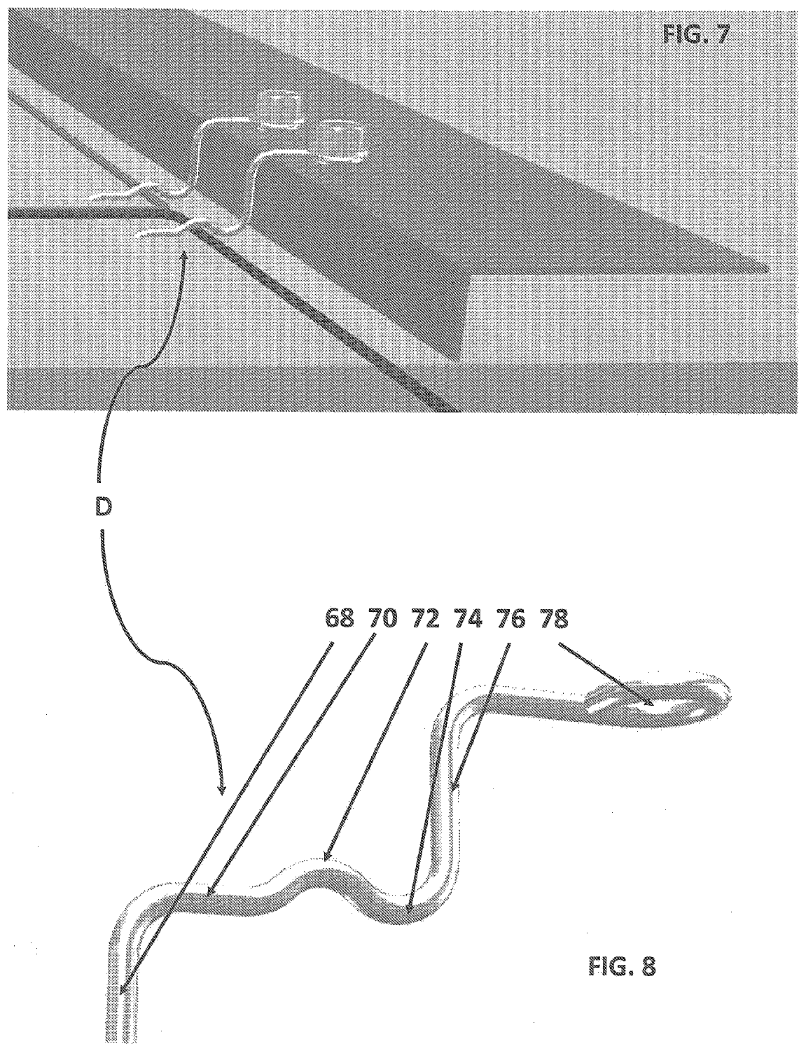

Furthermore, FIG. 8 shows the preferred hardware strut D having a fastener hole 78 which extends to a first leg 77 which extends to a perpendicular leg 76 which extends to a bend 74 which creates a hump 72 for one or more conductors (not shown) to fit thereunder, which extends to a second leg 70 which extends to a perpendicular impaling pin 68. In one embodiment, one or more hump 72 may be made for the preferred hardware strut D.

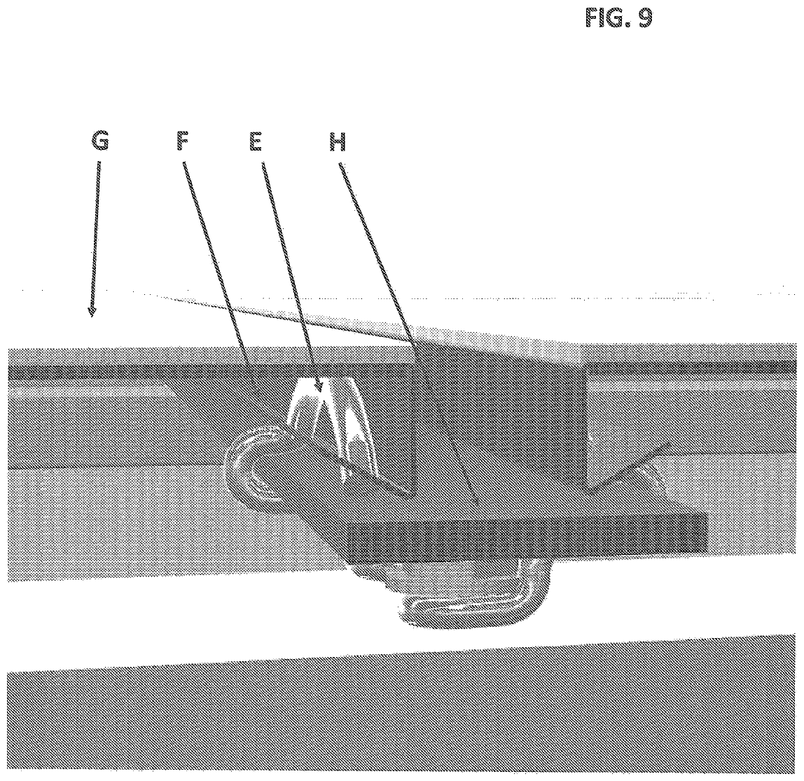

According to a fifth preferred embodiment of the present invention, FIG. 9 shows a solar panel clip E attached to a substrate (not numbered) via fastener (not numbered), and interconnected with a frame F which is structurally attached to a solar thin film with an anti-reflective lens G. A replacement reveal H is located between the solar panel clips E and under the bottom of the frames F.

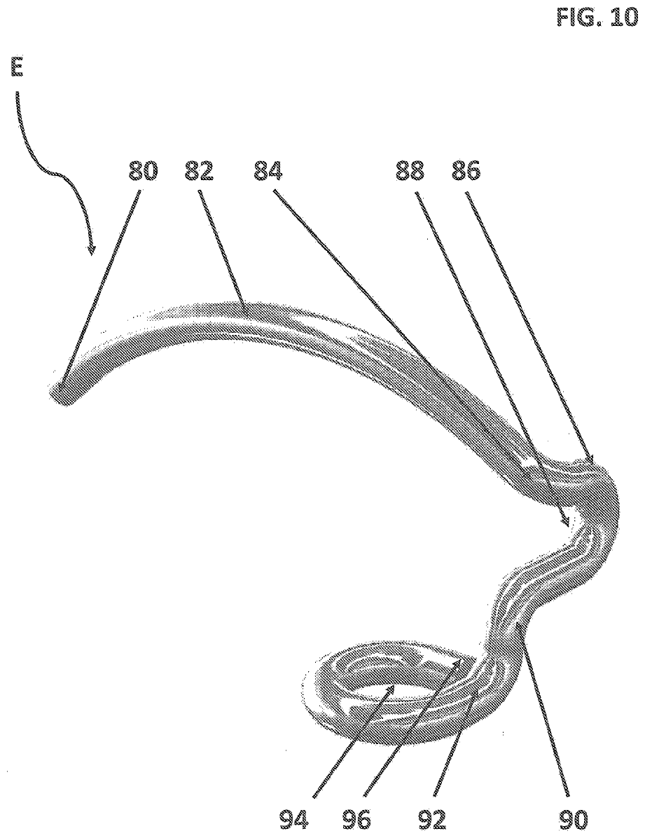

Moreover, FIG. 10 shows the solar panel clip E having a first end 80 extending to an arch 82 which extends to a first bend 84 which extends perpendicular to an extended bend 86 which creates a slot 88 for the replacement reveal (not shown) to rest within and adjacent to and between a first perpendicular leg 87A and a second perpendicular leg 89A. Further, the second perpendicular leg 89A extends to a second bend 90 and a third bend 92 which create an “S” shape. The third bend 92 extends to a loop 94 which terminates in a second end 96.

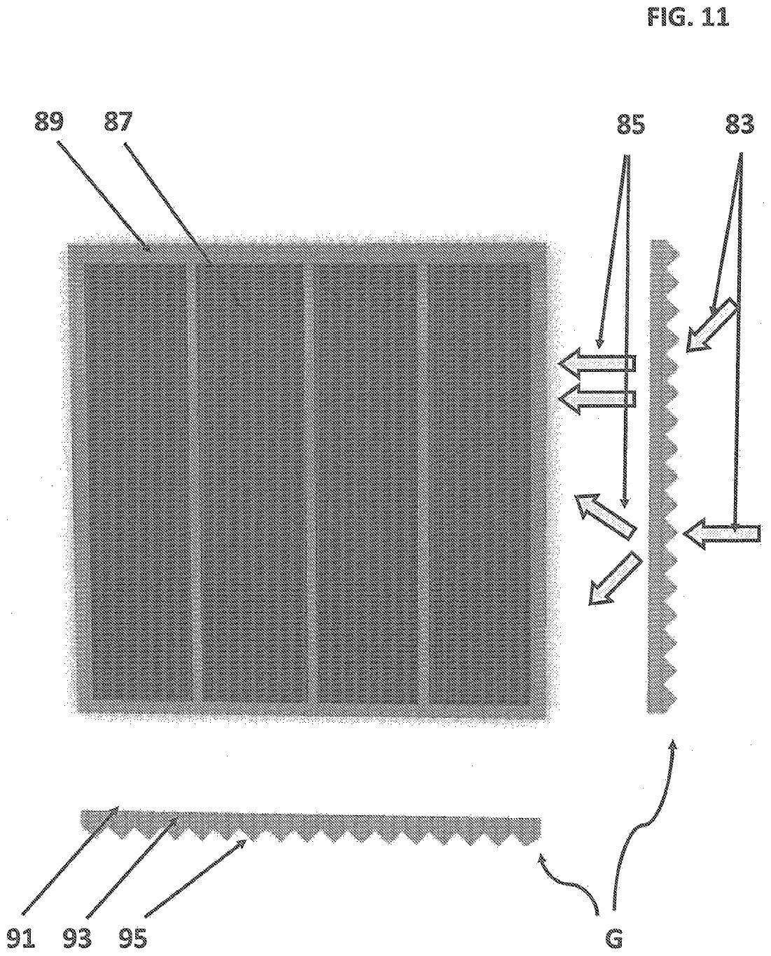

According to an embodiment of the present invention, FIG. 11 shows the anti-reflection lens G having 2 alternate mounting solutions shown based on the orientation of a solar panel 89 and being located in a field 87. An adhesive 91 may be used to adhere a lens 93 to the field 87 with a plurality of ridges 95 shaped and oriented in a direction within the field 87 which captures the most sunlight 83 throughout the year. Further, the sunlight 83 is redirected 85 based on the angle of incidence of the sunlight 83 to the anti-reflective lens G, as shown in FIG. 11.

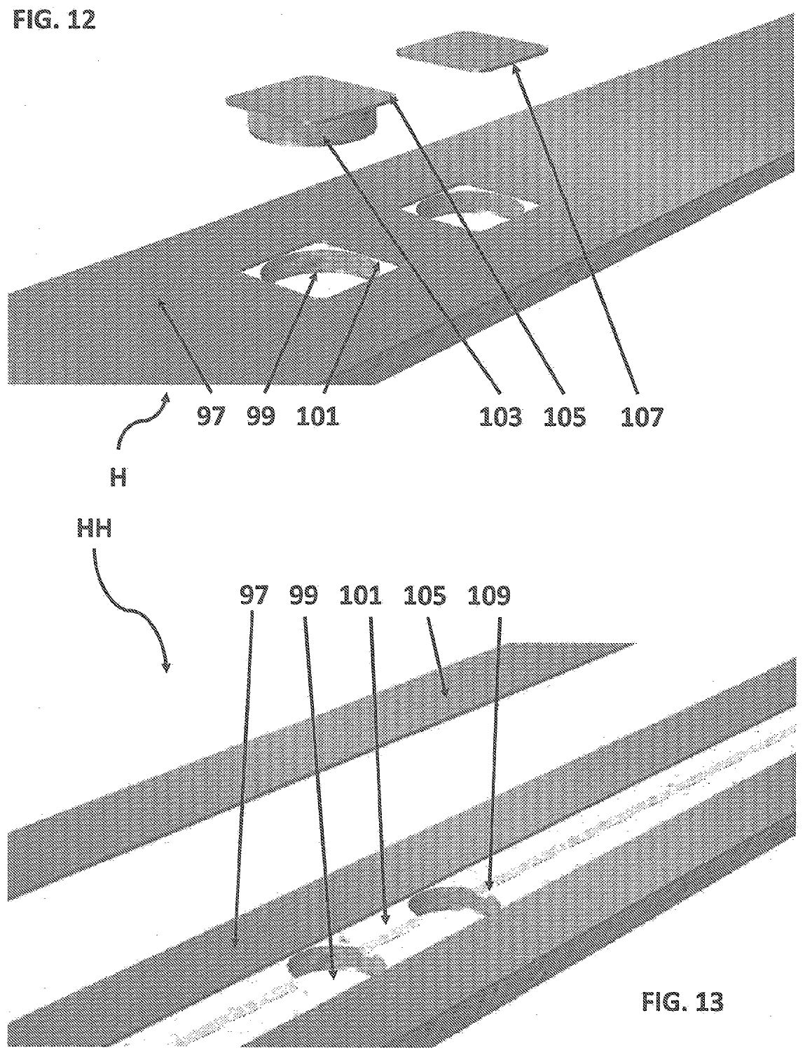

According to an embodiment of the present invention, FIG. 12 shows the replacement reveal H having a surface 97 with at least one hole 99 and removed sections 101 as shown in the middle.

Further, the replacement reveal H comprising a first replacement cap 105 with a body 103 attached while a second replacement cap 107 does not have an attached body. Adhesive (not shown) is used to adhere both the replacement caps 105, 107 over the respective removed sections 101 and the hole 99.

According to an alternate embodiment of the present invention, FIG. 13 shows an alternate replacement reveal HH having a surface 97′ with removed sections 101′ and a valley 109 and with at least one hole 99′. Further, a replacement cap 105′ is adhered to the removed sections 101′ and excess adhesive (not shown) is funneled down the valley 109 and ejected through the hole 99′ so as not to dirty the exposed side of the replacement cap 105′ and the surface 97′.

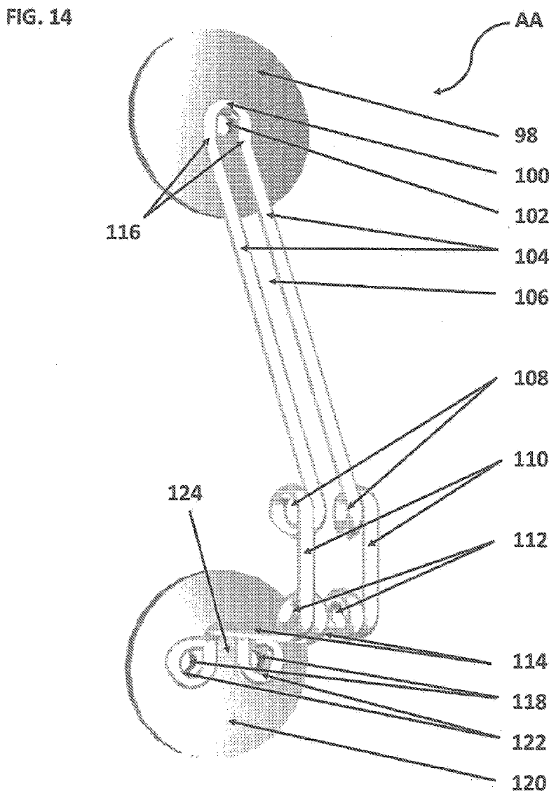

FIG. 14 shows another preferred embodiment of the thermal mounting clip AA having mirrored sides comprising of a first loop 100 creating a fastener slot 102 which terminates at two parallel bends 116 to prevent movement of fastener (not shown). The parallel bends 116 extend to dead load legs 104 which create a slot 106 for sub-girt (not shown) to rest therebetween. The dead load legs 104 extend to first holes 108 which extend to parallel arms 110 which then extend to second holes 112. The second holes 112 extend to dynamic load legs 114 which extend to perpendicular fastener loops 122 which create fastener holes 118. The fastener holes 118 match up with fastener holes of a stainless steel/EPDM isolator 123, and a space 124 between the perpendicular fastener loops 122 is adjustable to minimize the distance between the dynamic load legs 114. A stainless-steel portion 120 of the isolator 123 acts to distribute loads more evenly to the substrate (not shown).

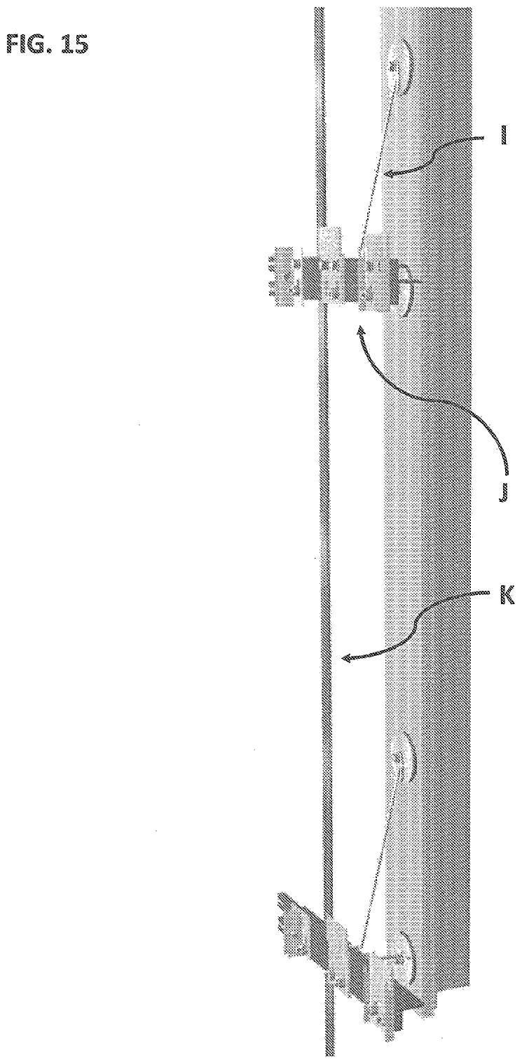

According to an embodiment of the present invention, FIG. 15 shows a horizontal thermal clip I, adjustable clips J and girt stabilizers K in an assembly.

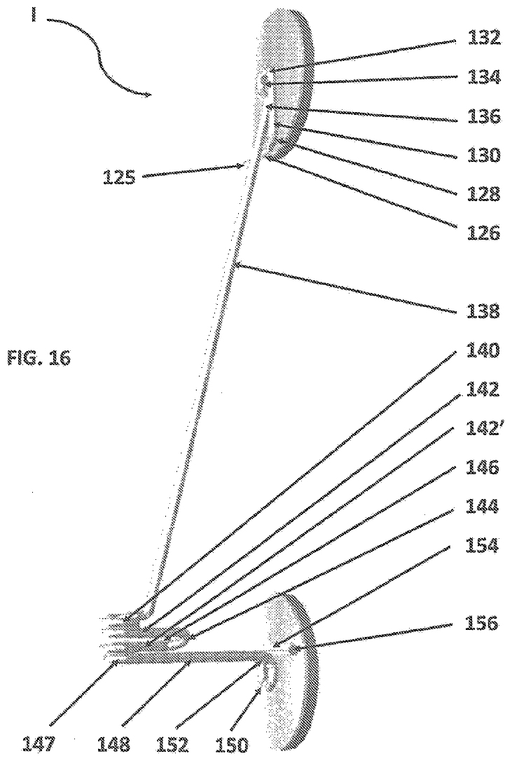

Now referring to FIG. 16, the horizontal thermal clip I having a first end 125 extending into a first leg 126 extending to a first bend 128 which extends perpendicular to a second leg 130 which extends to a first loop 132 which creates a fastener hole 134. The first loop 132 extends to a second bend 136 which prevents movement of fastener (not shown) when inserted into the fastener hole 134. The second bend 136 extends to a dead load arm 138 which extends to a first coil 140 which extends to a first parallel leg 142 which extends to a second loop 144 which extends to a second parallel leg 142′ to create a slot 146 between both the parallel legs 142, 142′. The second parallel leg 142′ extends to a second coil 147 which extends to a third leg 148 which extends to a perpendicular fastener loop 150 which extends to a fourth leg 152 which extends to a perpendicular leg 154 which terminates in a second end 156.

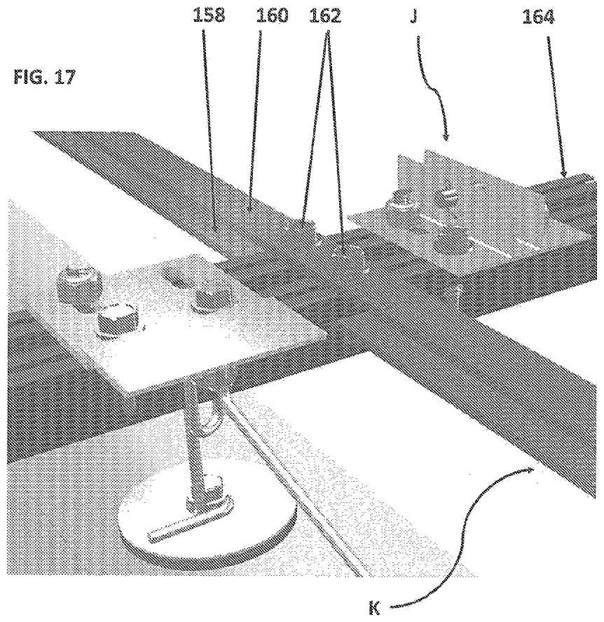

FIG. 17 shows a dual T-slot sub-girt 164 with girt stabilizers K attached through a hole (not shown) with a first stabilizer 158 on the bottom and a second stabilizer 160 on top, and all fastened together with fasteners 162.

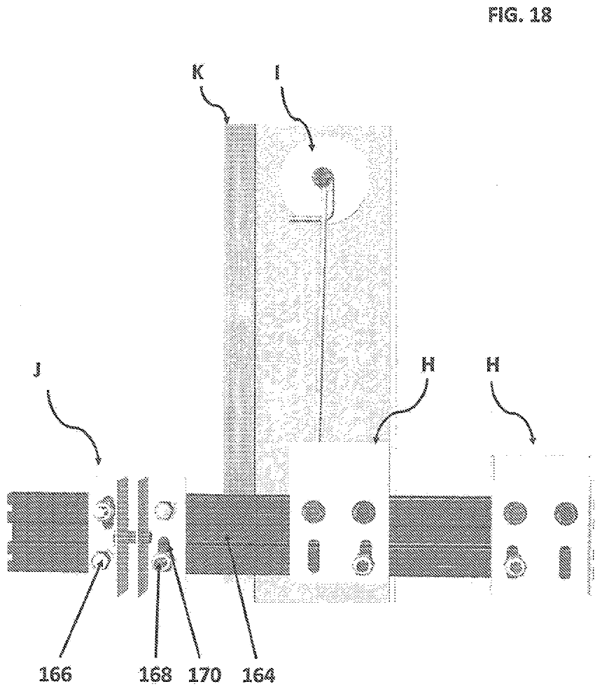

FIG. 18 shows adjustable clips J attached to the dual T-slot sub-girt 164 first via adjustable T-slot fasteners 168 through an adjustment slot 170, and with permanent attachment to the dual T-slot sub-girt 164 via permanent fasteners 166.

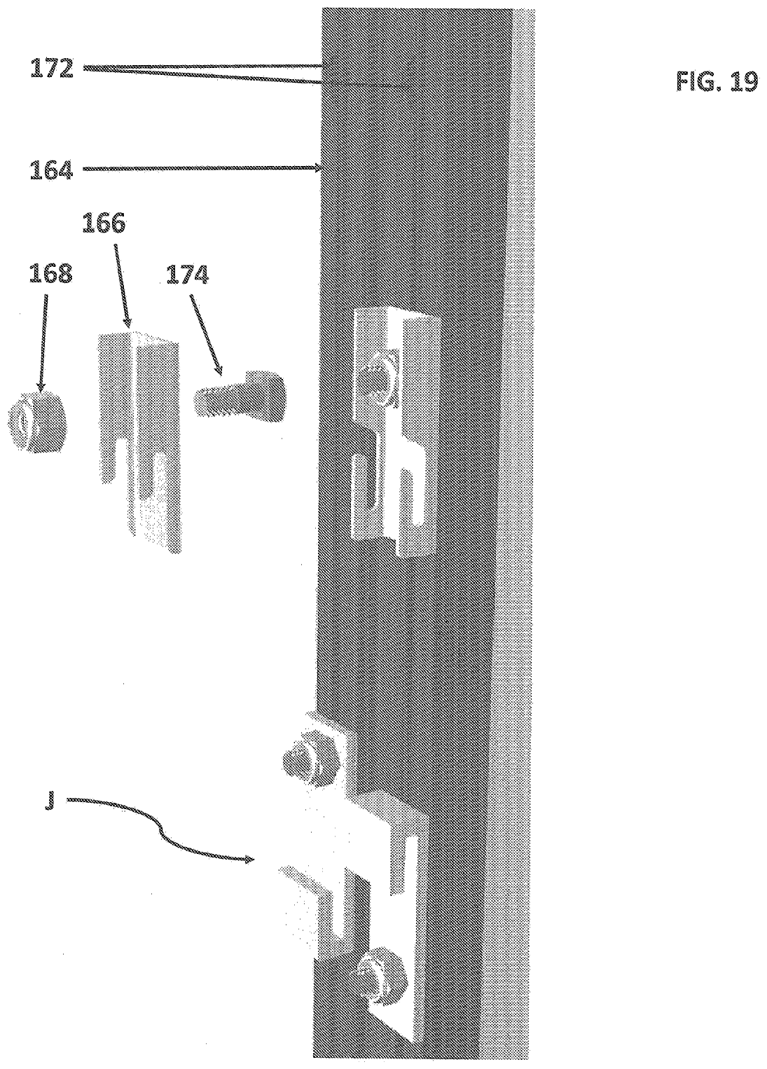

FIG. 19 shows the dual T-slot sub-girt 164 having holes 172 for fasteners 174 to enter somewhere in the middle of the dual T-slot sub-girt 164. The fastener 174 is then placed through a hole (not shown) in an adjustable clip 167 and captured with a nut 168.

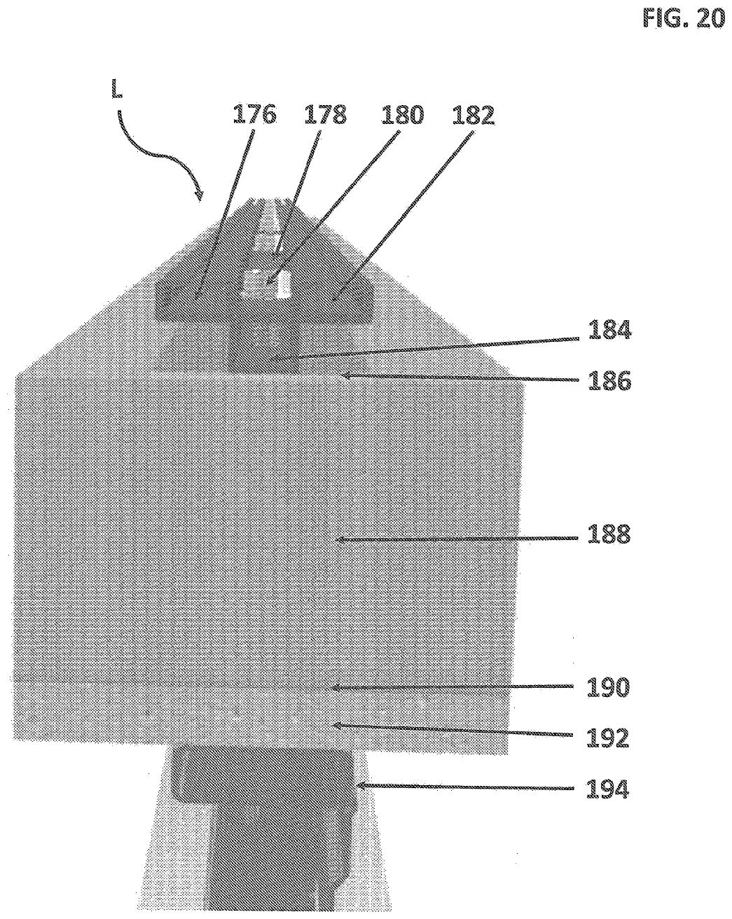

According to an embodiment of the present invention, FIG. 20 shows a dual T-slot continuous insulation sub-girt L having a first T-slot 176 and a second T-slot 182 with a first web 178 therebetween. A fastener 180 pass through the first web 178 and a second web 184 to permanently fix the position of the fastener 180 to the sub-girt L. The fasteners 180 then pass through a compression plate 186 (if used), an insulation 188, a weather barrier 190, a sheathing 192 and through a stud 194 for permanent yet adjustable fixing.

In one embodiment, FIG. 21 shows a solar panel clip E′ attached through a sheathing 200 and a weather barrier 198 via fasteners 196. The solar panel clip E′ supports a panel F independent of a reveal strip (not numbered). A surface 195 may be a solar or non-conductive façade material.

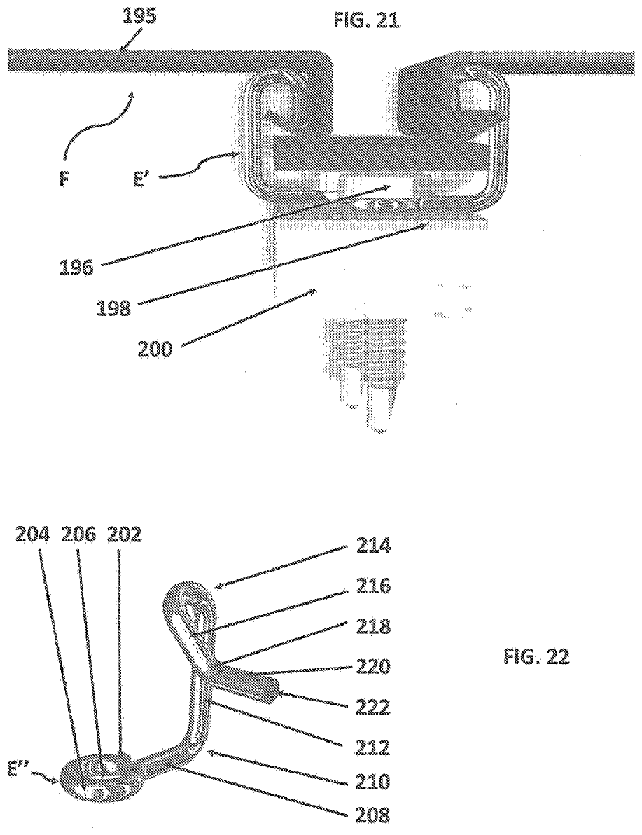

Referring to FIG. 22, the solar panel clip E″ having a first end 222 extending to a first arm 220 which extends to a first bend 218 which extends to a second arm 216 which then extends to a first loop 214. The first loop 214 extends perpendicular to the substrate with a third arm 212 which extends to a second bend 210 which then extends to a perpendicular arm 208 which extends to a second loop 204 which creates a fastener hole 206. The second loop 204 extends to a second end 202 which is bent upwards to act as a fastener anti-reversal mechanism.

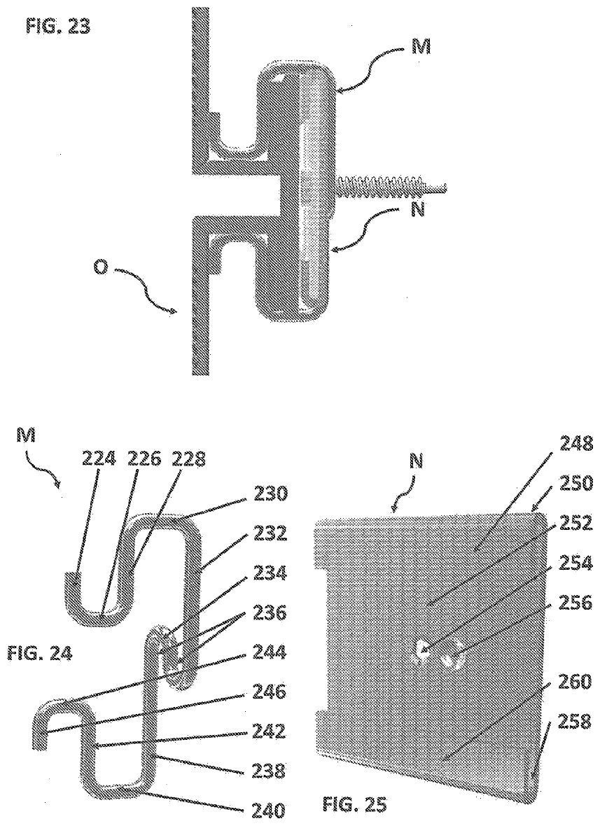

In alternate embodiment, FIG. 23 shows a preferred solar panel clip M connected to a support washer N via a fastener (not numbered) as well as multiple solar panels O.

FIG. 24 shows the preferred solar panel clip M having a first arm 224 which extends to a first perpendicular arm 226 which then extends to a second perpendicular arm 228 which extends to a third perpendicular arm 230 which extends to a fourth perpendicular arm 232 which then extends to a S-turn 234 which creates multiple attachment slots 236. The S-turn 234 extends to a second arm 238 which extends to a fifth perpendicular arm 240 which then extends to a sixth perpendicular arm 242 which extends to a seventh perpendicular arm 244 which terminates at an eighth perpendicular arm 246.

FIG. 25 shows the support washer N having a first reveal mounting surface 248 extending to a first open hem 250 which extends to a base 252 which extends to a second open hem 258 which extends to a second reveal mounting surface 260. At least one anti-reversal serrated hole 254 is in the base 252 and at least one optional anti-spin indent 256.

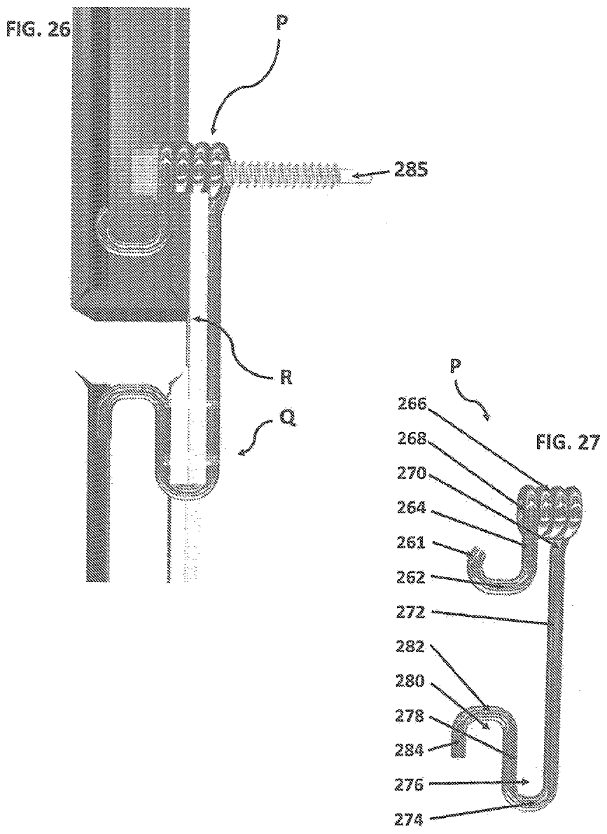

In alternate embodiment, FIG. 26 shows a solar panel clip P connected to solar panels (not numbered) along with a structural reveal R via staple fasteners Q. A fastener 285 is shown inside of the alternate solar panel clip P.

FIG. 27 shows the alternate solar panel clip P having a radiused end 261 extending to a first leg 262 which extends to a first perpendicular leg 264 which extends to a coil 266 having a hole 268 within. The coil 266 extends to a first bend 270 which extends to a second leg 272 which extends to a turn 274 which extends to a parallel leg 278 to create a first slot 276 between the parallel leg 278 and the second leg 272. The parallel leg 278 extends to a second perpendicular leg 282 which extends to a perpendicular termination leg 284, with a second slot 280 created between the termination leg 284 and the parallel leg 278.

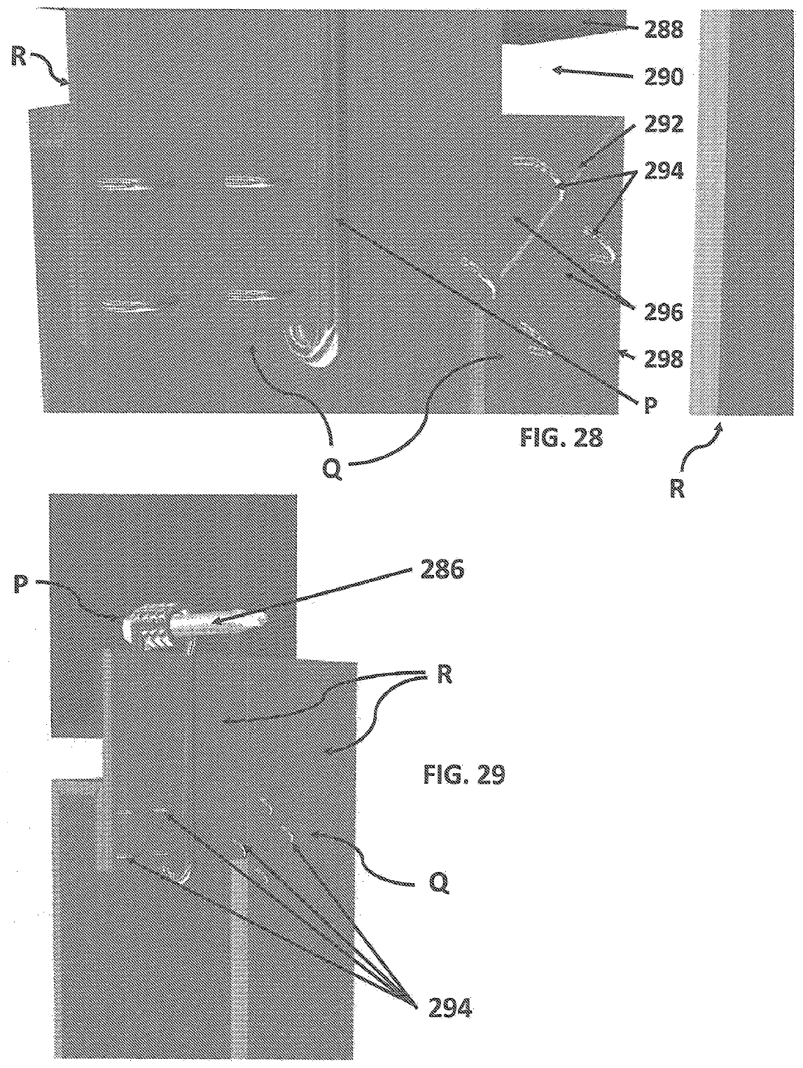

FIG. 28 shows structural reveals R attached to panel returns 296 of a first panel 298 via staple fasteners Q and having a reveal opening 290 between the first panel 298 and a second panel 288. The first panel 298 shows a flange gap 292 being closed by the staple fastener Q's formed ends 294.

Furthermore, FIG. 29 shows the assembly of FIG. 28 having the structural reveal R on the right structurally attached to the panel flanges (not numbered) via the formed staple fastener Q ends 294. A backside rout 293 allows for flange 295, which is located inside of the panel flanges (not numbered) to be bend inwards and into the panel so that water ingress is pushed inside the first panel 298.

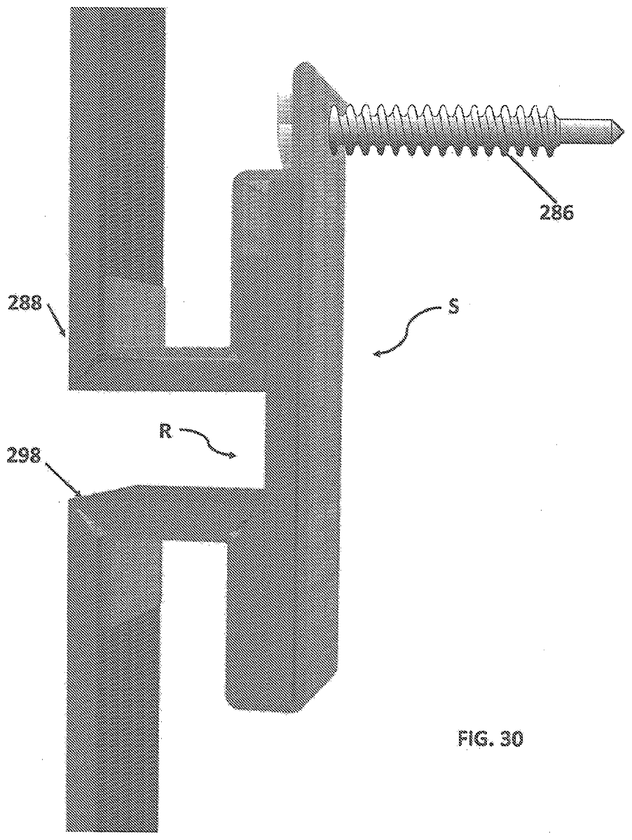

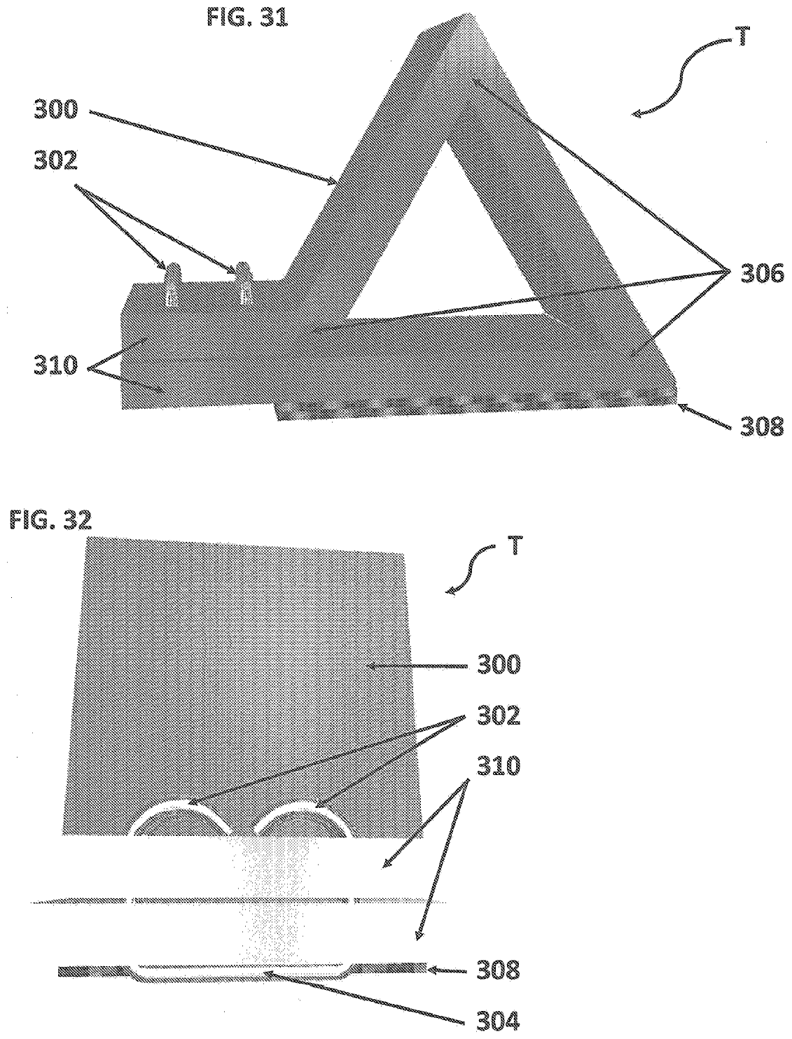

FIG. 30 shows an alternate extruded or formed sheet metal solar panel clip S attached to the first panel 298 and the second panel 288 with a fastener 286 inside hole (not shown) of the clip S. According to an embodiment of the present invention, FIG. 31 shows a stiffener T comprised of routs 306 to make all bends (not numbered). A segment 300 is at an angle to allow staple fasteners formed ends 302 to be driven through and then onto segments 310 to permanently affix the triangular shape of the stiffener T.

Further, FIG. 32 shows the stiffener T better showing how a staple fastener 304 with the formed ends 302 pass through the segments 310. The staple fastener 304 may be attached at any orientation to provide better stiffener strength, not just the orientation shown. The stiffener T to be used where solar panel deflection (not shown) needs strengthening.

While the foregoing embodiments of the application have been set forth in considerable particularity for the purposes of making a complete disclosure of the invention, it may be apparent to those of skill in the art that numerous changes may be made in detail without departing from the spirit and principles of the application. Additionally, combinations and interchangeability or inter-use of components and embodiments should be considered apparent to the spirit and principles of the application, and in which all terms are meant in their broadest, reasonable sense unless otherwise indicated. Any headings utilized within the description are for convenience only and have no legal or limiting effect.

1. A solar mounting system, said system comprising:
a thermal mounting clip A with an isolator AB configured to be attached to a substrate, wherein said thermal mounting clip A is adapted to reduce thermal transfer into a building, and said isolator AB is adapted to spread the pressure of loads over a larger surface of the building's substrate as well as to help prevent water from entering the substrate underneath said isolator AB;
a sub-girt configured to be attached to said thermal mounting clip A;
a microinverter strut B mechanically attached to a microinverter, and further fastened to said sub-girt and a cooler/heat sink C;
said cooler/heat sink C attached with said microinverter and said microinverter strut B, adapted to keep said microinverter and other electric/electronic equipment away from contact with an insulation and/or panels; and
a hardware strut D configured to be structurally attached to an additional adjacent sub-girt and adapted to support hardware.

2. The system of claim 1, wherein said thermal mounting clip A comprising: a first end which extends substantially horizontally to a substantially perpendicular first bend, which extends to a first leg which extends to a second bend which creates a loop for a fastener to pass through it and said isolator AB, wherein said second bend extends to a third bend which extends to a static support leg which extends to a first loop, which extends to a second leg which extends to a second loop which extends to a first perpendicular leg which extends to a second perpendicular leg which extends to a third loop which creates a hole for a fastener to pass through it and said isolator AB, wherein said third loop extends to a parallel leg which extends to a third perpendicular leg which terminates at a second end.

3. The system of claim 1, wherein said microinverter strut B comprising: a mounting hole extending to a leg which extends to a first bend which extends to a first perpendicular leg which extends to a second bend which extends to a second perpendicular leg which extends to and terminates at a mounting coil.

4. The system of claim 3, wherein said microinverter strut B pushes down on said insulation when not in contact with said cooler/heat sink C.

5. The system of claim 1, wherein said cooler/heat sink C comprising: a plurality of holes on all sides, a plurality of mounting surfaces on top and bottom for attachment to said microinverter and fasteners, and a plurality of vertical supports are located in many places.

6. The system of claim 5, wherein said cooler/heat sink C is designed to have minimal contact with the devices in order to block as little heat as possible.

7. The system of claim 5, wherein said cooler/heat sink C allows air to pass all around the devices, while at the same time helps as a heat sink to draw some of the heat away from the device.

8. The system of claim 5, wherein said cooler/heat sink C may be made to allow said microinverter to be similarly covered from all sides to prevent contact with any materials, allowing for un-interrupted cooling from all directions.

9. The system of claim 5, wherein said cooler/heat sink C may be made in an extrusion process if made of aluminum with holes machined out of it, injection molded as a complete part if made of plastic, or 3D printed of almost any material including fiber reinforced plastics.

10. The system of claim 1, wherein said hardware strut D comprising: a fastener hole which extends to a first leg which extends to a perpendicular leg which extends to a bend which creates a hump for one or more conductors to fit thereunder, which extends to a second leg which extends to a perpendicular impaling pin.

11. The system of claim 10, wherein said hardware strut D may comprises one or more hump.

12. The system of claim 10, wherein said hardware strut D may comprises one or more independent locations to support conduits, conductors, pipes, and other materials which pass therethrough.

13. The system of claim 10, wherein said hardware strut D may impale said insulation to support and prevent said insulation from moving.

14. The system of claim 10, wherein said hardware strut D may be coated with an insulation material to help prevent electrical and thermal conductivity as well as to help reduce vibration for noise reduction.

15. The system of claim 10, wherein said hardware strut D may act as a heat sink to pull heat away from devices such as microinverters.

16. The system of claim 1, may comprises a solar panel mounting clip E attached to a substrate via fastener, and interconnected with a frame F which is structurally attached to a solar thin film with an anti-reflective lens G, wherein said solar panel clip E comprising: a first end extending to an arch which extends to a first bend which extends perpendicular to an extended bend which creates a slot for a replacement reveal H to rest within and adjacent to and between a first perpendicular leg and a second perpendicular leg, wherein said second perpendicular leg extends to a second bend and a third bend which create an “S” shape, and further said third bend extends to a loop which terminates in a second end.

17. The system of claim 16, wherein solar panels are mechanically attached to building without fastening said solar panel mounting clip E to said solar panel itself.

18. The system of claim 16, wherein attachment holes of said solar panel mounting clip E may be fastened into the sub-framing or substrate to permanently fix said solar panel mounting clips in a fixed position, which then supports and holds said solar panels in a fixed position thereby.

19. The system of claim 1, may comprises a thermal mounting clip AA having mirrored sides comprising: a first loop creating a fastener slot which terminates at two parallel bends to prevent movement of fastener, wherein said parallel bends extend to dead load legs which create a slot for sub-girt to rest therebetween, wherein said dead load legs extend to first holes which extend to parallel arms which then extend to second holes, wherein said second holes extend to dynamic load legs which extend to perpendicular fastener loops which create fastener holes which match up with fastener holes of a stainless steel/EPDM isolator, and a space between said perpendicular fastener loops is adjustable to minimize the distance between said dynamic load legs.

20. The system of claim 19, wherein a stainless-steel portion of said isolator acts to distribute loads more evenly to the substrate.

21. The system of claims 2 and 19, wherein said thermal mounting clips may be used over said isolator AB or a stainless EPDM backed washer isolator when connected to said substrate in order to help reduce thermal transfer into the building.

22. The system of claim 21, wherein said washer may be made of a material such as stainless steel with or without an EPDM type of backer and manufactured with a turret press to add anti-reversal mechanisms, protrusions, and convex shapes while a break press may be used to create hems or other bends required.

23. The system of claims 2 and 19, wherein said thermal mounting clips may be triangularly shaped to obtain maximum performance for supporting loads, and the triangular shape may be made using one or more wires.

24. The system of claims 2 and 19, wherein said thermal mounting clips may be made to accommodate vertical, horizontal, and diagonal sub-girts.

25. The system of claims 2 and 19, wherein said thermal mounting clips may be used vertically for walls or horizontally for roofs and soffits.

26. The system of claim 1, may comprises a horizontal thermal clip I to support said sub-girt and adjustable panel clips of various types, wherein said horizontal thermal clip I comprising: a first end extending into a first leg extending to a first bend which extends perpendicular to a second leg which extends to a first loop which creates a fastener hole, wherein said first loop extends to a second bend which prevents movement of fastener when inserted into the fastener hole, wherein said second bend extends to a dead load arm which extends to a first coil which extends to a first parallel leg which extends to a second loop which extends to a second parallel leg to create a slot between both the parallel legs, said second parallel leg extends to a second coil which extends to a third leg which extends to a perpendicular fastener loop which extends to a fourth leg which extends to a perpendicular leg which terminates in a second end.

27. The system according to any preceding claims, wherein said thermal mounting clips, said hardware struts, and said solar panel clips may be made up of a fully hardened stainless or galvanized carbon steel spring wires and formed on manual or automated wire bending machines.

28. The system of claim 27, wherein said wires may be welded, press formed and/or twist formed together to make any conceivable shape.

29. The system of claim 27, wherein ends of said wires may have threads added by use of dies so that male threaded ends can connect into female threaded attachments.

30. The system of claim 27, wherein said wires may be formed into coils so that when a screw is inserted into it, said coil will allow said screw to enter but reversing said screw will tighten said coils to help prevent it from backing out or cause enough additional friction to prevent said screw from backing out.

31. The system according to any preceding claims, wherein said thermal mounting clips, said hardware struts, and said solar panel clips may have holes or slots for mechanical fasteners to either hold them fixed or allow them to move within said slots.

32. The system according to any preceding claims, wherein said thermal mounting clips, said hardware struts, and said solar panel clips may have one or more mounting holes to help prevent formed wire movement and can add rigidity.

33. The system according to any preceding claims, wherein said thermal mounting clips, said hardware struts, and said solar panel clips may have plastics, foams, butyl materials, adhesives, self-locking washers and/or other materials added onto or adjacent to them for better thermal performance, as a safety coating including for electrical insulation, to minimize vibration, or to help connect or otherwise interact with itself or other materials by being more or less sticky or prone to wear.

34. The system according to any preceding claims, wherein said thermal mounting clips, said hardware struts, and said solar panel clips are a lightweight, strong, durable, inexpensive, and seismic rated solar panel mounting system with the best thermal efficiency which can be used on any structure, but particularly on the sides of buildings, or Building Integrated Photovoltaics (BIPV).

35. The system according to any preceding claims, wherein said thermal mounting clips, said hardware struts, and said solar panel clips support the dead load of said solar panel from a top only, and then to attach a bottom of an adjacent solar panel above into the same solar panel attachment clip without any fastening at all so that installation of said solar panels is very fast and economical to do in the field.
